(19) United States
(12) Patent Application Publication
(10) Pub. No.: US 2024/0296212 A1
(43) Pub. Date: Sep. 5, 2024

(54) Code Reader Device and Computer-Implemented Method for Operating the Code Reader Device

(71) Applicant: SICK AG, Waldkirch (DE)

(72) Inventors: Frank SCHÜTZ, Waldkirch (DE); Daniel REICHELT, Waldkirch (DE)

(21) Appl. No.: 18/584,106

(22) Filed: Feb. 22, 2024

(30) Foreign Application Priority Data
Mar. 7, 2023 (DE) 102023105668.9

(51) Int. Cl. G06F 21/32; G06K 7/10; G10L 15/06

(52) U.S. Cl. CPC G06F 21/32; G06K 7/10732; G10L 15/063

(57) ABSTRACT

A code reader device for reading an optical code that allows easy access to functions and a secure modification of the functions of the code reading device includes an illumination unit to illuminate a reading area of the code reading device, a receiver unit to capture the code from the reading area, an evaluation unit to determine information from the code, and an audio unit to capture acoustic signals from a voice of a user. The evaluation unit is trained to carry out a voice learning process in order to teach and store a recorded voice as an individual voice of an authorized user, so that the voice is stored as a personalized voice of the authorized user. The evaluation unit is further trained to carry out a voice recognition process in which the personalized voice is recognized as the voice of the authorized user.

The invention relates to a code-reading device for reading an optical code according to claim 1 and a computer-implemented method for operating the code-reading device according to claim 10.

Such a code reader device is used in many areas of everyday life to read information data from an optical code, whereby the optical code can be in the form of a barcode, two-dimensional codes (e.g. QR code, data matrix code) or other codes (e.g. color codes, dot codes). In this case, the code reader has an illumination unit to expose a reading area of the code reader or the optical code. In addition, the code reader device has a receiver unit that is used to receive light emitted by the optical code, so that the optical code can be detected as the code passes through a reading area of the code reader device and signals can be generated from the received light to determine the information data of the optical code.

Such a code reader is widely used, for example, in the retail sector at supermarket checkouts or in logistics for automatic parcel identification, for sorting postal items or for baggage handling in airports and other logistics applications.

If a code-reading device is put into operation by a user or an adjustment has to be made to the code-reading device, for example because types of optical code change or parameters have to be adapted to plant processes, then a computer with a suitable connection to the code-reading device is usually necessary in order to re-parameterize the code-reading device accordingly and to change the configuration of the code-reading device.

Due to application-specific installation of the code reading device, such as on a conveyor belt or in a logistics high-bay warehouse, easy and obstacle-free access to the code reader device is not always guaranteed.

Furthermore, the proper operation of the code reader device may be jeopardized by access to the configuration of the code reader device by an unauthorized user.

It is therefore an object of the invention to provide a code-reading device for reading an optical code, which allows easy yet secure (in the sense of authorized) access to the code-reading device in order to be able to make permissible changes to it.

This object is solved by a code-reading device with the features of claim 1.

The code reader according to the invention for reading an optical code comprises an illumination unit for illuminating a reading area of the code reading device, a receiver unit for capturing the code from the reading area, an evaluation unit for determining information of the code, and an audio unit for capturing acoustic signals from a user's voice, wherein the evaluation unit is trained to perform a voice learning process in order to interpret a recorded voice as a to teach and store the individual voice of an authorized user, so that the voice is stored as the personalized voice of the authorized user, and whereby the evaluation unit is further trained to carry out a voice recognition process in which the personalized voice is recognized as the voice of the authorized user, and is further trained to perform defined functions of the code reader device only if a call to the function is made by the personalized voice of the authorized user has been detected.

The voice recognition process thus enables the code reader device to uniquely assign the personalized voice of the authorized user to the defined function, so that only the authorized user can call up this defined function of the code reader device with his or her voice or cause it to be executed.

According to a preferred embodiment, the voice learning process is designed to start the learning of the authorization of the user by means of a defined speech sequence, a password or a fingerprint. For this purpose, in particular, a microphone or a fingerprint sensor is provided to carry out the authorization. By determining the correct speech sequence, password or fingerprint, the user is identified as an authorized user.

Furthermore, in particular, the defined speech sequence is stored in the control of the code reader device and intended for recognition or teaching of the voice of the authorized user through the voice recognition process. In this case, the voice recognition process of the code reader device prompts the user to be authorized to the defined speech sequence.

When the user says the defined speech sequence, the voice recognition process uses the defined speech sequence to start the learning or recognize the user's voice.

Recognition is the process of comparing a stored voice of an authorized user with the recorded voice. If a match is detected, then the captured voice is recognized as the personalized voice of the authorized user and the defined function is released for the personalized voice.

Advantageously, artificial intelligence is envisaged that learns the voice of the authorized user in a machine learning process and distinguishes the voice of the authorized user from the voices of others, especially unauthorized users. The artificial intelligence, which is integrated into the voice recognition process and stored in the control of the code reading device, performs machine learning of the speech sequence given by the user and assigns the learned voice to the authorized user, so that the user is recognizable as an authorized user by his/her voice.

According to another preferred embodiment, the defined function which is assigned to the authorized user includes starting or stopping of a measurement of the code-reading device or a configuration of the code-reading device.

Advantageously, the voice recognition process is designed to prioritize the recognized voices and assign differently prioritized functions of the code reader device according to the prioritization of the voices. This means that the voice assigned to an authorized expert can, for example, activate or deactivate non-safety-related and safety-related functions of the code reader device wherein, for example, the voice associated with an unauthorized user can only enable or disable the code reader device's display feature, but not any highly prioritised features of code reader device like the configuration.

Furthermore, it is preferable that the taught-in and personalized voice can be stored in a memory of the code reading device and transferred to evaluation units of other code reading devices. In particular, the taught-in and personalized voice can also be stored in a cloud or in storage outside the code reading device. This makes an additional voice learning process obsolete and simplifies the process of executing the voice recognition process on the other code reading devices. The authorized user's voice is transmitted to the other code-reading devices from the cloud or external storage to the other code-reading devices.

According to a preferred embodiment, the evaluation unit is trained to indicate acoustically or visually to the authorized user whether the voice recognition process has been successfully carried out or not. As a result, the user is immediately informed whether the defined function, such as the configuration, of the code reader device is available to him or not.

It is a further object of the present invention to provide a computer-implemented method for operating the code-reading device, which enables easy access to functions and a safe modification of the functions of the code-reading device.

According to the inventive subject matter, the problem is solved by a computer-implemented method for operating a code reader device that has an audio unit for capturing acoustic signals from a user's voice, including the following steps:-
Capturing a speech sequence of the user,
Teach-in an authorized user's voice as an individual voice and save the voice as a personalized voice, and
Sharing a defined function of the code reader device with the authorized user associated with the personalized voice, and
Execute the defined function when a function call is detected by the audio unit as a voice command with the personalized voice.

The computer-implemented method makes it easy to configure code reading devices that are difficult to access due to their operating position. Above all, it is ensured that only the personalized voice of the authorized user activates or deactivates the function assigned with the voice, whereby the function assigned to the voice is, for example, a security-related function of the code reading device.

According to a preferred embodiment, a defined voice sequence, password or fingerprint is captured to confirm an authorization of the user and initiate the personalization of the voice. Advantageously, the voice is machine-learned by means of artificial intelligence, so that different voices can be distinguished from each other on the basis of learned voice patterns. In this case, the voice recognition process prompts the user to reproduce the defined speech sequence. Once the voice has been recognized and assigned to the authorized user, the function approved and defined for the voice can be activated or deactivated by the voice of the authorized user. In particular, a measurement operation or a configuration of the code reader device is started or terminated with the personalized voice of the authorized user.

The voice of the authorized user, personalized by the computer-implemented procedure, is stored as a data record that is transmitted to other code-reading devices, so that the defined function of these additional code-reading devices is released to the authorized user. As a result, the authorized user is easily able to access and, in particular, configure multiple, interconnected code reading devices of a measurement system.

Advantageously, recognized voices are differentiated in order to prioritize the voices differently and to grant the prioritized voices access rights to the corresponding defined function of the code reading device. This means, for example, that safety-related and thus high-priority functions, such as the configuration of the code reader device, is assigned or released to the high-priority voice of the authorized user. Non-safety-related functions, such as displaying information of the code reader device, is released or assigned to the low-priority voice of the unauthorized user, so that the unauthorized user can be securely excluded from configuring the code reading device.

Preferred embodiments and further features as well as further advantages of the invention can be found in the dependent claims, the following description and the drawings.

In the following, the invention is described in detail by means of embodiments with reference to the drawing. In the drawing the figures show:

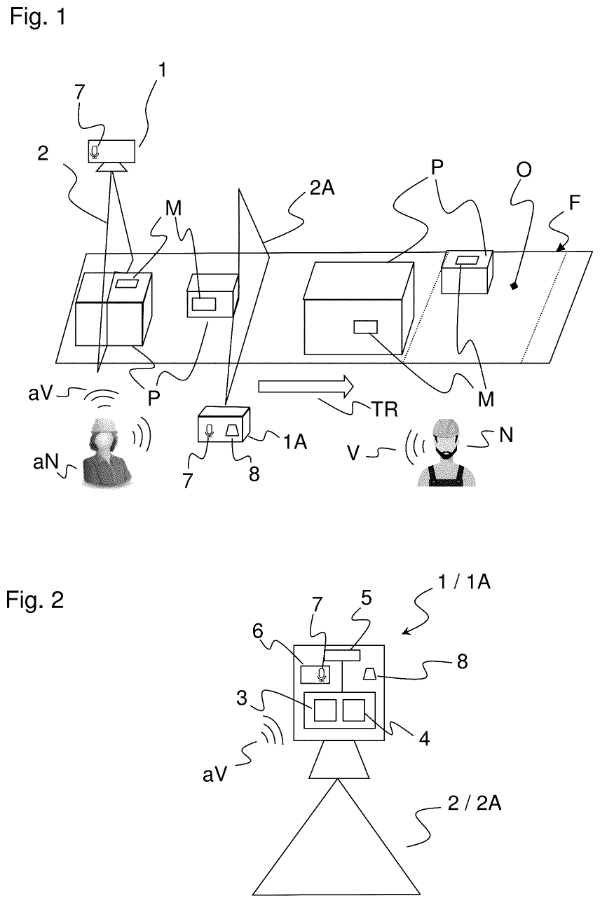

FIG. 1 a schematic perspective representation of a measuring system for a conveyor belt;

FIG. 2 a schematic representation of a code reader device according to the invention; and

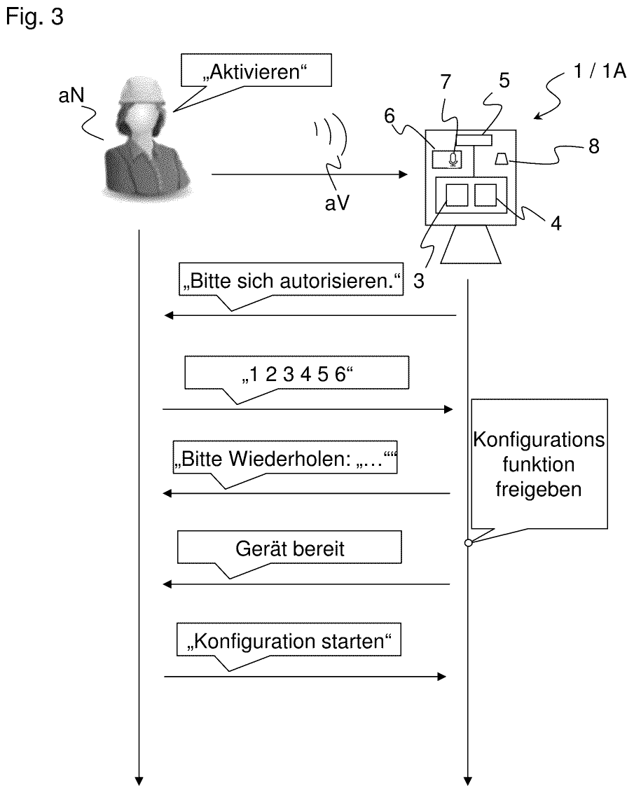

FIG. 3 a schematic representation of a preferred embodiment of a voice recognition process of the code reader according to the invention.

FIG. 1 schematically shows a conveyor belt F on which parcels P are transported in the direction of transport TR according to the black arrow shown, for example, to a sorter that is not shown. The application example of conveyor belt F includes two code reading devices 1 and 1A, which are arranged on the conveyor belt F in such a way that each reading range 2 and 2A of the code reading devices 1 and 1A is directed towards the conveyor belt F in order to capture the packages P transported through the reading areas 2 and 2A of the code reading devices 1 and 1A.

Depending on the use case and configuration of the respective code reader device 1 or 1A, the code reader devices 1 and 1A can capture the same or different information from codes M provided on the packets P for a user N or aN.

In the application example shown in FIG. 1, the first code reader 1, which is located at the beginning of the conveyor belt F with respect to the transport direction TR of the packages P, is intended to capture the codes M arranged on the top O. The second code reader 1A, which is located next to the first code reader 1, is intended to capture laterally arranged codes M. In this case, the code M is formed on a sticker as a barcode or as a two-dimensional code.

In order to provide the reading range 2 or 2A, the code reader 1 or 1A according to the invention has, as shown schematically in FIG. 2, an illumination unit 3 which illuminates the reading area 2 or 2A of the code reader device 1 or 1A, and a receiver unit 4 which captures the code from the reading range 2 or 2A. The information of the code is determined by an evaluation unit 5 of the code reader device 1 or 1A.

According to the inventive subject matter, an audio unit 6 is provided which acoustically captures a voice V or aV of the user N or aN. The acoustic signals are transmitted to the evaluation unit 5, which is trained to carry out a voice learning process in order to recognize and store the recorded voice V as an individual voice aV of an authorized user aN, so that the voice V is stored as the personalized voice aV of the authorized user aN. In this context, it is particularly advantageous to provide for an artificial intelligence that automatically learns the personalized voice aV of the authorized user aN and later in the recognition process distinguishes the personalized voice aV of the authorized user aN from voices V of others, especially unauthorized users N. The artificial intelligence is preferably stored in evaluation unit 5.

After the voice of the authorized user aN has been taught, a voice V can be recognized as the personalized voice aV of the authorized user aN in a subsequent voice recognition process. Once the authorized user aN has been recognized in this way, defined functions of the code reader device 1 or 1A are activated, i.e. can be called up and executed. However, this only happens if the corresponding voice command for the function originates from the authorized user aN and not from an unauthorized user. So not only is the activation of the functions user-based, but also the actual call (with execution) of the function is only for the authorized user aN.

In particular, the function released to the authorized user aN may include starting or stopping a measurement of the code reader device 1 or 1A or a configuration of the code reader device 1 or 1A.

In other words, the voice recognition process allows the authorized user aN to access the configuration of the code reader device 1 or 1A with a voice command, since the voice recognition process has assigned and released the configuration function of the code reader device 1 or 1A to the personalized voice aV of the authorized user aN. On the other hand, the voice recognition process also allows the authorized execution of the voice command for a specific function. In addition, the voice command can enable the authorized user aN to enable or disable hardware elements of the code reader device 1 or 1A. The hardware elements include, for example, buttons or communication interfaces, such as USB or SD card slots, of the code reader device 1 or 1A. With his trained voice aV, the authorized user aN is thus able to activate control buttons by voice command or protect them from manipulation.

Furthermore, the voice learning process is designed to start an authorization of user N by means of a defined speech sequence, a password or a fingerprint. In particular, the authorization of user N as authorized user aN must be carried out at the start of the voice learning process. For this purpose, a microphone 7 or a fingerprint sensor 8 is preferred, with which the authorization of user N can be carried out.

As in the example of the application of conveyor belt F shown in FIG. 1, it is simply possible for the authorized user aN to perform a configuration of the code reader device 1 by calling the configuration function of the code reader device 1 with a voice command, despite the installation of the code reader device 1 above the conveyor belt F.

In the following, a preferred embodiment of the inventive, computer-implemented method for operating the code reader device 1 and 1A is described with reference to FIG. 3.

User N or aN acoustically activates the code reader device 1 or 1A, for example by communicating a command stored in the evaluation unit 5 of the code reader device 1 or 1A to the code reader device 1 or 1A.

The code reader device 1 or 1A detects the command and activates the voice recognition process stored in the evaluation unit 5, so that the code reader device 1 or 1A prompts the user N or aN to prove his authorization by pronouncing a speech sequence, a password or by means of a fingerprint scan. In this case, the voice sequence, the password or the fingerprint is stored in the evaluation unit 5.

If user N does not give authorization because the required speech sequence could not be captured, the voice recognition process of the code reader device 1 or 1A learns the captured voice V of user N as the voice V of an unauthorized user N. Thus, user N, who is registered as unauthorized, can activate the code reader device 1 or 1A with his voice V and display its information. However, user N is not able to access high-priority, especially security-relevant functions, such as configuring the code reader device 1 or 1A.

If an authorization is captured where the voice sequence, password, or fingerprint is correctly communicated to the code reader device 1 or 1A, the voice recognition process of the code reader device 1 or 1A prompts the authorized user aN to repeat a defined speech sequence.

The voice recognition process recognizes and classifies the voice reproducing the defined speech sequence as an individual voice aV of the authorized user aN, so that the voice aV is personalized. In particular, the personalized voice aV is machine-trained by means of artificial intelligence or recognized by means of a comparison with a stored voice pattern of the authorized user aV. As a result, different voices V and aV are differentiated from each other on the basis of learned voice patterns.

At least one defined function of the code reader device 1 or 1A is released to the authorized user aN assigned to the personalized voice aV. The defined function is executed when a voice command with the personalized voice aV is captured by the audio unit 6. In particular, a measurement operation or a configuration of the code reader device 1 or 1A is started or terminated with the personalized voice aV.

This means that the authorized user aN is able to start and stop defined functions of the code reader device 1 or 1A with his personalized voice aV by voice command. In particular, the authorized user aN can configure the code reader device 1 or 1A, even if, as shown in FIG. 1, he does not have barrier-free access to the code reader device 1. In particular, the defined enabled functions of the code reader device 1 or 1A may also include activating or deactivating hardware elements, such as buttons, buttons or communication interfaces, in particular USB or SD card slots, by voice command, so that the authorized user can protect such hardware elements from manipulation, for example, by means of a voice command.

Preferably, the personalized voice aV of the authorized user aN is stored as a data record that can be transmitted to other code reading devices 1A, so that defined functions of these other code reading devices are also released for the authorized user aN. The authorized user aN is thus able to activate or deactivate the functions of the other code reading devices 1A by means of his voice aV.

### REFERENCE MARK LIST

1, 1A Code Reader Device
2, 2A Code Reader Device Reading Area
3 Lighting unit
4 Receiver unit
5 Evaluation
6 Audio Unit
7 Microphone
8 Fingerprint sensor
at Authorized User
Av Personalized/Authorized Voice
F Conveyor belt
M Codes
N User
O Top
P Parcel
TR Transportrichtung
V Voice

1. Code reader device (1, 1A) for reading an optical code, with
a lighting unit (3) to illuminate a reading area (2, 2A) of the code reader device (1, 1A),
a receiver unit (4) for capturing the code from the reading area (2, 2A),
an evaluation unit (5) to determine information from the code, and
an audio unit (6) for recording a user's (aN, N) voice (aV, V),
wherein the evaluation unit (5) is trained to carry out a voice learning process in order to teach and store a voice (aV or V) as an individual voice (aV) of an authorized user (aN), so that the voice (aV) is stored as a personalized voice (aV) of the authorized user (aN), and
wherein the evaluation unit (5) is trained to carry out a voice recognition process in which the personalized voice (aV) is recognized as the voice of the authorized user (aN) and is further trained to perform defined functions of the code reading device (1, 1A) only if the personalized voice (aV) of the authorized user (aN) has been recognized.

2. The code reader device (1, 1A) according to claim 1, wherein the evaluation unit is further trained to start the voice teach-in process only if an authorization of the user (aN) has been established by means of a defined speech sequence, a password or a fingerprint.

3. A code reader device (1, 1A) according to claim 2, wherein a microphone (7) or a fingerprint sensor (8) is provided to perform the authorization.

4. The code-reading device (1, 1A) according to claim 2, wherein the defined speech sequence is stored in the evaluation unit (5) of the code-reading device (1, 1A) and intended to recognize the voice of the authorized user (aN) by the voice recognition process.

5. A code-reading device (1, 1A) according to claim 1, wherein the defined function released to the authorized user (aN) comprises a start or stop of a measurement of the code-reading device (1, 1A) or a configuration of the code-reading device (1, 1A).

6. A code reader device (1, 1A) according to claim 1, wherein an artificial intelligence is provided, for machine learning of the voice (aV) of the authorized user (aN) and for distinguishing the voice (aV) of the authorized user (aN) from voices (V) of other, in particular unauthorized, users (N).

7. The code reader device (1, 1A) according to claim 1, wherein the voice recognition process is designed to perform a prioritization of the recognized voices (aV) and to assign differently prioritized functions of the code reader device (1, 1A) according to the prioritization of the voices.

8. A code-reading device (1, 1A) according to claim 1, wherein the taught-in and personalized voice (aV) is storable in a memory of the code-reading device (1, 1A) and transferable to evaluation units (5) of other code-reading devices (1, 1A).

9. A code reader device (1, 1A) according to claim 1, wherein the evaluation unit (5) is designed to indicate acoustically or visually to the authorized user (aN) whether the voice recognition process has been successfully performed or not.

10. Computer-implemented method for operating a code reader device (1, 1A) that has an audio unit (6) for capturing acoustic signals from a user's (aN, N) voice (V or aV), comprising the steps:
Capturing a speech sequence of the user (aN, N),
Teach-in the voice (V) of an authorized user (aN) as an individual voice (aV) and save the voice (aV) as a personalized voice (aV), and
Sharing a defined function of the code reader device (1, 1A) with the authorized user (aN) associated with the personalized voice (aV), and
Executing the defined function when a function call is captured as a voice command with the personalized voice (aV) from the audio unit (5).

11. A computer-implemented method according to claim 10, wherein a defined speech sequence, password or fingerprint is captured in order to confirm an authorization of the user (aN) and to initiate the personalization of the voice.

12. A computer-implemented method according to claim 10, wherein the voice (V, aV) is trained by machine learning of an artificial intelligence, so that different voices (V, aV) are distinguished from each other on the basis of learned voice patterns.

13. A computer-implemented method according to claim 10, wherein a measurement operation or a configuration of the code reader device (1, 1A) is started or terminated with the personalized voice (aV).

14. A computer-implemented method according to claim 10, wherein the personalized voice (aV) of the authorized user (aN) is stored as a record which is transmitted to further code-reading devices (1, 1A), so that the defined function of these additional code-reading devices (1, 1A) is released to the authorized user (aN).

15. Computer-implemented method according to claim 10, wherein recognized voices (V, aV) are differentiated in order to prioritize the voices (V, aV) differently and to grant the prioritized voices (aV) access rights to the corresponding defined function of the code reader device (1, 1A).
